(19) United States
(12) Patent Application Publication
(10) Pub. No.: US 2008/0049259 A1
(43) Pub. Date: Feb. 28, 2008

(54) Image processing method carrying out verification of correctness of embedment data and identification of embedment data, data detection method, image processing apparatus, and recording medium recording computer program therefor

(75) Inventor: Motohiro Asano, Osaka-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.,

(21) Appl. No.: 11/894,096

(22) Filed: Aug. 20, 2007

(30) Foreign Application Priority Data
Aug. 22, 2006 (JP) 2006-225459(P)
Jun. 14, 2007 (JP) 2007-157820(P)

(51) Int. Cl. G06K 15/02

(52) U.S. Cl. 358/3.28

(57) ABSTRACT

A data division unit divides embedment data into a plurality of blocks. A checksum calculation unit calculates a checksum of data for each of the plurality of blocks resultant from division by the data division unit, and calculates a checksum of entire data to be embedded. Then, an image data synthesis unit synthesizes image data by embedding in the image data, data for each block, a block checksum, an entire checksum, and an identification number of the block. Therefore, by detecting such information from a printed matter, verification of correctness of the embedded data and identification of the embedded data can be carried out.

This application is based on Japanese Patent Applications Nos. 2006-225459 and 2007-157820 filed with the Japan Patent Office on Aug. 22, 2006 and on Jun. 14, 2007, respectively, the entire content of which is hereby incorporated by reference.

### BACKGROUND OF THE INVENTION

1. Field of the Invention

The present invention relates to a technique for embedding embedment data in an original image, and more particularly to an image processing method capable of carrying out verification of correctness of embedded embedment data and identification of the embedment data, a data detection method, an image processing apparatus, and a recording medium recording a computer program therefor.

2. Description of the Related Art

A technique for embedding embedment data as electronic watermark in image data which is an original image has recently been developed. The inventions disclosed in Japanese Laid-Open Patent Publication No. 2001-358926 (hereinafter referred to as Patent Document 1) and Japanese Laid-Open Patent Publication No. 2004-128845 (hereinafter referred to as Patent Document 2) relate to this technique.

In an image processing apparatus disclosed in Patent Document 1, when image data is entered, a checksum is calculated for a prescribed number of pixels, the calculated checksum is embedded as electronic watermark in the image data, and the image data is recorded on a recording medium. When the image data recorded on the recording medium is reproduced, the embedded checksum is compared with a checksum calculated from the reproduced image data, to determine whether modification has been made or not.

According to a method of embedding watermark information disclosed in Patent Document 2, a dot pattern is configured to include at least first, second and third dots (a starting point dot, a level reference dot, a modulation dot), and a value is set for the dot pattern in accordance with a characteristic value determined by relative positional relation among the first, second and third dots. The characteristic value is an inner product of a vector having the third dot as a starting point and the first dot as an end point and a vector having the third dot as a starting point and the second dot as an end point.

Here, an example in which image data having embedment data embedded as electronic watermark is printed out and thereafter the printout is scanned by a scanner or the like so as to detect the embedded data will be considered. When a plurality of printouts, for example two printouts, are arranged side by side and scanned at a time, a plurality of types of embedment data embedded in respective printouts should be identified and detected.

Patent Document 1 described above, however, is directed to determination as to whether modification has been made or not, by comparing the embedded checksum with the checksum calculated from the reproduced image data, and therefore, Patent Document 1 is not able to verify the embedded data (checksum). If a plurality of printouts are arranged side by side and scanned, the embedment data embedded in respective printouts cannot be identified.

In addition, according to Patent Document 2 described above, a value is set for the dot pattern in accordance with the characteristic value determined by relative positional relation among the first, second and third dots. Accordingly, if a plurality of printouts are arranged side by side and scanned, the embedment data embedded in respective printouts cannot be identified, as in the case of Patent Document 1.

### SUMMARY OF THE INVENTION

An object of the present invention is to provide an image processing method capable of verification of correctness of embedded data and identification of the embedded embedment data, a data detection method, an image processing apparatus, and a recording medium recording an image processing program.

According to one aspect of the present invention, an image processing method for embedding embedment data in an original image includes the steps of: dividing the embedment data into a plurality of blocks; calculating a specific value from data for each resultant block, by using a unidirectional function; generating identification information specific to the embedment data; and embedding the specific value, the identification information, and the data of each block in the original image for each block.

Therefore, by detecting these kinds of information, verification of correctness of the embedded data and identification of the embedded data can be carried out.

Preferably, the unidirectional function is a checksum.

Therefore, verification of correctness of the data and identification of the data can be carried out with simplified operation.

Preferably, the unidirectional function is a hash function.

Therefore, verification of correctness of the data can accurately be carried out.

Preferably, the unidirectional function is a function for performing addition after performing bit blend on the data.

Therefore, verification of correctness of the data can accurately be carried out.

Further preferably, the unidirectional function is a function for performing addition after performing shift operation on the data.

Therefore, verification of correctness of the data can accurately be carried out with simplified operation.

Further preferably, the unidirectional function is a function for performing addition after dividing the data at a prescribed bit length.

Therefore, verification of correctness of the data can accurately be carried out with simplified operation.

Preferably, the unidirectional function is cyclic redundancy check.

Therefore, verification of correctness of the data can accurately be carried out with simplified operation.

Preferably, the identification information is a value calculated from the entire embedment data by using a second unidirectional function.

Therefore, verification of correctness of the embedded data and identification of the embedded data can further accurately be carried out.

Further preferably, the second unidirectional function is a checksum.

Therefore, verification of correctness of the data and identification of the data can be carried out with simplified operation.

Further preferably, the second unidirectional function is a hash function.

Therefore, verification of correctness of the data can accurately be carried out.

Further preferably, the second unidirectional function is a function for performing addition after performing bit blend on the data.

Therefore, verification of correctness of the data can accurately be carried out.

Further preferably, the second unidirectional function is a function for performing addition after performing shift operation on the data.

Therefore, verification of correctness of the data can accurately be carried out with simplified operation.

Further preferably, the second unidirectional function is a function for performing addition after dividing the data at a prescribed bit length.

Therefore, verification of correctness of the data can accurately be carried out with simplified operation.

Further preferably, the second unidirectional function is cyclic redundancy check.

Therefore, verification of correctness of the data can accurately be carried out with simplified operation.

Preferably, the data of each block is embedded in the original image, together with a block identification number provided for each block.

Therefore, verification of correctness of the embedded data can further accurately be performed.

According to another aspect of the present invention, a data detection method of detecting embedment data embedded in a printed image includes the steps of: reading an image from a printed matter; detecting data for each block of the embedment data, a specific value calculated from the data for each block by using a unidirectional function, and identification information specific to the embedment data, from the read image; verifying correctness of the data based on a value calculated from the detected data for each block by using the unidirectional function and the detected specific value; and determining combination of the data for each block, based on the detected identification information.

Therefore, verification of correctness of the embedded data and identification of the embedded data can simultaneously be carried out.

Preferably, the unidirectional function is a checksum.

Therefore, verification of correctness of the data and identification of the data can be carried out with simplified operation.

Preferably, the unidirectional function is a hash function.

Therefore, verification of correctness of the data can accurately be carried out.

Preferably, the unidirectional function is a function for performing addition after performing bit blend on the data.

Therefore, verification of correctness of the data can accurately be carried out.

Further preferably, the unidirectional function is a function for performing addition after performing shift operation on the data.

Therefore, verification of correctness of the data can accurately be carried out with simplified operation.

Further preferably, the unidirectional function is a function for performing addition after dividing the data at a prescribed bit length.

Therefore, verification of correctness of the data can accurately be carried out with simplified operation.

Preferably, the unidirectional function is cyclic redundancy check.

Therefore, verification of correctness of the data can accurately be carried out with simplified operation.

Preferably, the identification information is a value calculated from the entire embedment data by using a second unidirectional function, and the data detection method further includes the step of verifying correctness of the data based on the value calculated from the detected entire embedment data by using the second unidirectional function and the detected identification information.

Therefore, not only verification of correctness of the data for each block but also verification of correctness of the entire data can be carried out.

Further preferably, the second unidirectional function is a checksum.

Therefore, verification of correctness of the data and identification of the data can be carried out with simplified operation.

Further preferably, the second unidirectional function is a hash function.

Therefore, verification of correctness of the data can accurately be carried out.

Further preferably, the second unidirectional function is a function for performing addition after performing bit blend on the data.

Therefore, verification of correctness of the data can accurately be carried out.

Further preferably, the second unidirectional function is a function for performing addition after performing shift operation on the data.

Therefore, verification of correctness of the data can accurately be carried out with simplified operation.

Further preferably, the second unidirectional function is a function for performing addition after dividing the data at a prescribed bit length.

Therefore, verification of correctness of the data can accurately be carried out with simplified operation..

Further preferably, the second unidirectional function is cyclic redundancy check.

Therefore, verification of correctness of the data can accurately be carried out with simplified operation.

Preferably, the data detection method further includes the steps of detecting a block identification number provided for each block of the embedment data from the read image; and reproducing the entire embedment data from the data for each block, based on the block identification number.

Therefore, verification of correctness of the data for each block can further accurately be carried out.

According to yet another aspect of the present invention, an image processing apparatus for embedding embedment data in an original image includes: a division unit dividing the embedment data into a plurality of blocks; a calculation unit calculating a specific value from data for each block resultant from division by the division unit, by using a unidirectional function; a generation unit generating identification information specific to the embedment data; and an embedding unit embedding the specific value, the identification information, and the data of each block in the original image for each block.

Therefore, by detecting these kinds of information, verification of correctness of the embedded data and identification of the embedded data can be carried out.

According to yet another aspect of the present invention, a data detection apparatus detecting embedment data embedded in a printed image includes: a reading unit reading an image from a printed matter; a detection unit detecting data for each block of the embedment data, a specific value calculated from the data for each block by using a unidirectional function, and identification information specific to the embedment data, from the image read by the reading unit; a verification unit verifying correctness of the data based on a value calculated, by using the unidirectional function, from the data for each block detected by the detection unit and the specific value detected by the detection unit; and a determination unit determining combination of the data for each block, based on the identification information detected by the detection unit.

Therefore, verification of correctness of the embedded data and identification of the embedded data can simultaneously be carried out.

According to yet another aspect of the present invention, there is provided a computer readable recording medium storing a computer program for embedding embedment data in an original image, by causing a computer to execute the steps of: dividing the embedment data into a plurality of blocks; calculating a specific value from data for each resultant block, by using a unidirectional function; generating identification information specific to the embedment data; and embedding the specific value, the identification information, and the data of each block in the original image for each block.

Therefore, by detecting these kinds of information, verification of correctness of the embedded data and identification of the embedded data can be carried out.

According to yet another aspect of the present invention, there is provided a computer readable recording medium storing a computer program for detecting embedment data embedded in a printed image, by causing a computer to execute the steps of: reading an image from a printed matter; detecting data for each block of the embedment data, a specific value calculated from the data for each block by using a unidirectional function, and identification information specific to the embedment data, from the read image; verifying correctness of the data based on a value calculated from the detected data for each block by using the unidirectional function and the detected specific value; and determining combination of the data for each block, based on the detected identification information.

Therefore, verification of correctness of the embedded data and identification of the embedded data can simultaneously be carried out.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates an example of a system configuration of an image processing apparatus in a first embodiment of the present invention.

FIG. 2 further functionally illustrates the image processing apparatus shown in FIG. 1.

FIG. 3 illustrates another example of a system configuration of the image processing apparatus in the first embodiment of the present invention.

FIG. 4 is a block diagram showing a functional configuration (data embedment section) of the image processing apparatus shown in FIG. 1 or 3.

FIG. 5 is a flowchart for illustrating a processing procedure (data embedment section) of the image processing apparatus shown in FIG. 1 or 3.

FIG. 6 illustrates an example of data 46 to be embedded.

FIG. 7 illustrates an example of structure of data actually embedded in a background of image data 41.

FIG. 8 illustrates a method of calculating an entire checksum.

FIG. 9 illustrates a method of calculating a block checksum of a block 1.

FIG. 10 illustrates embedment data of block 1.

FIGS. 11A to 11C illustrate a bit pattern when data is embedded.

FIG. 12 illustrates rule of arrangement of the data to be embedded.

FIG. 13 illustrates a state that the data shown in FIG. 10 is actually embedded in accordance with the arrangement rule shown in FIG. 12.

FIG. 14 illustrates the embedment data when it is actually printed out as the background of image data.

FIG. 15 illustrates an example of a printout when the data is embedded in the background of the image data and printed.

FIG. 16 is a block diagram showing a functional configuration (data detection section) of the image processing apparatus shown in FIG. 1 or 3.

FIG. 17 is a flowchart for illustrating a processing procedure (data detection section) of the image processing apparatus shown in FIG. 1 or 3.

FIGS. 18A to 18C illustrate a standard pattern.

FIG. 19 illustrates an example where detected data of block 1 is correct.

FIG. 20 illustrates an example where detected data of block 1 is erroneous.

FIGS. 21A to 21F illustrate examples of detected data determined as correct by a detected data determination unit 53.

FIG. 22 shows a value of entire checksum when reconstructed data is erroneous.

FIG. 23 shows a value of entire checksum when reconstructed data is correct.

FIG. 24 illustrates an example where a print number is included in the embedment data and the data is printed out.

FIG. 25 illustrates an example where a value of checksum is calculated and embedded.

FIG. 26 illustrates an example where correctness of data is verified by using a hash function.

FIG. 27 illustrates data for checking, generated after bit blend shown in FIG. 26 is performed, when data is erroneous.

FIG. 28 illustrates another method of calculating data for checking.

FIG. 29 illustrates data for checking, generated after bit blend shown in FIG. 28 is performed, when data is erroneous.

FIG. 30 illustrates yet another method of calculating data for checking.

FIG. 31 illustrates data for checking, generated after bit blend shown in FIG. 30 is performed, when data is erroneous.

FIG. 32 illustrates an example of a CRC circuit.

FIG. 33 illustrates variation of each bit in a register when embedment data of 9 bytes shown in FIG. 6 is successively input to the CRC circuit.

### DESCRIPTION OF THE PREFERRED EMBODIMENTS

### First Embodiment

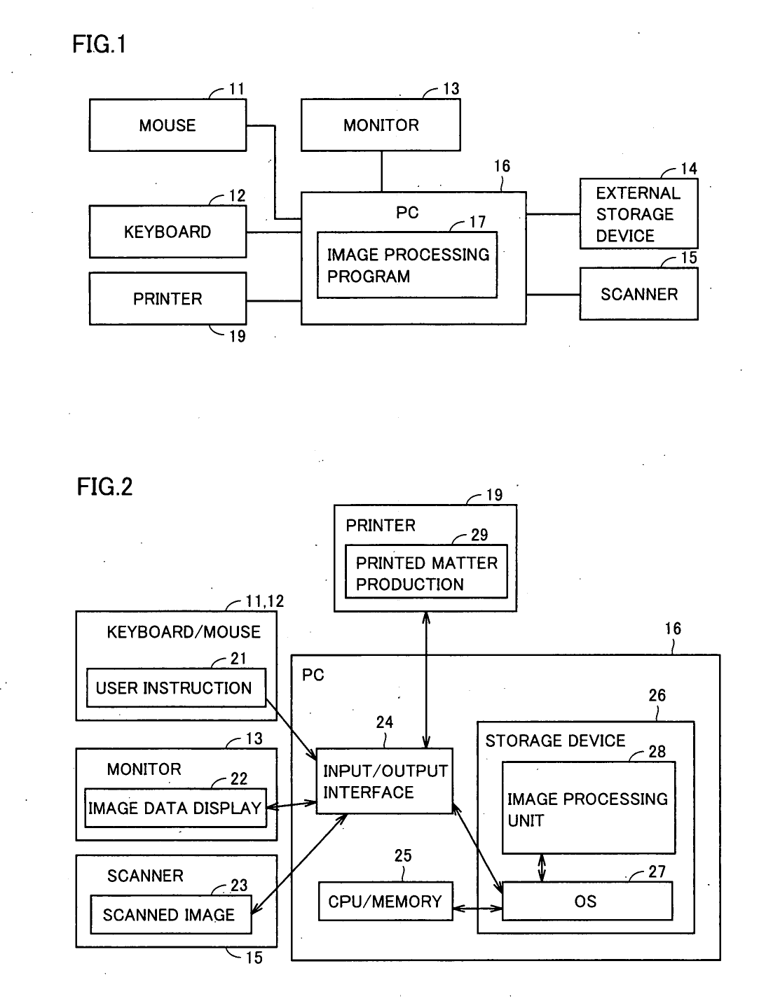

FIG. 1 illustrates an example of a system configuration of an image processing apparatus in a first embodiment of the present invention. FIG. 1 shows an example where the image processing apparatus is configured with a personal computer (hereinafter referred to as PC), and the image processing apparatus includes a mouse 11, a keyboard 12, a monitor 13, an external storage device 14, a scanner 15, a PC 16, and a printer 19.

PC 16 has a configuration the same as hardware of a general computer, and functions of the image processing apparatus which will be described later are attained by execution of an image processing program 17 stored on a recording medium by a CPU (Central Processing Unit) (see FIG. 2).

Mouse 11 and keyboard 12 are used as input devices, and they are used when a user starts up image processing program 17 or provides various instructions during execution of image processing program 17.

Monitor 13 is used for displaying image data or the like read by scanner 15, and the user provides an instruction to image processing program 17 while referring to what is displayed on monitor 13, whereby image processing proceeds.

External storage device 14 is used for storing image data or the like read by scanner 15. Image processing program 17 may be stored on a recording medium such as a hard disk within external storage device 14, loaded by PC 16 from external storage device 14 into an internal RAM (Random Access Memory), and executed.

Scanner 15 reads the image data in which data has been embedded, and outputs the read image data to PC 16. PC 16 performs processing which will be described later on the image data received from scanner 15, so as to perform image processing.

Printer 19 receives the image data that has been subjected to image processing from PC 16, and produces a printed matter in accordance with the image data.

FIG. 2 further functionally illustrates the image processing apparatus shown in FIG. 1. PC 16 includes an input/output interface 24, a CPU/memory 25, and a storage device 26. In addition, storage device 26 includes an OS (Operating System) 27 and an image processing unit 28 implemented by image processing program 17. Image processing program 17 operates on OS 27 and attains a function of image processing unit 28.

Image processing unit 28 controls keyboard 12, mouse 11, monitor 13, scanner 15, and printer 19 by inputting/outputting data through OS 27 and input/output interface 24. Receiving a user instruction 21 through keyboard 12 or mouse 11 as well as a scanned image 23 from scanner 15, image processing unit 28 performs image processing which will be described later. Consequently, image data display 22 on monitor 13 or printed matter production 29 by printer 19 is performed.

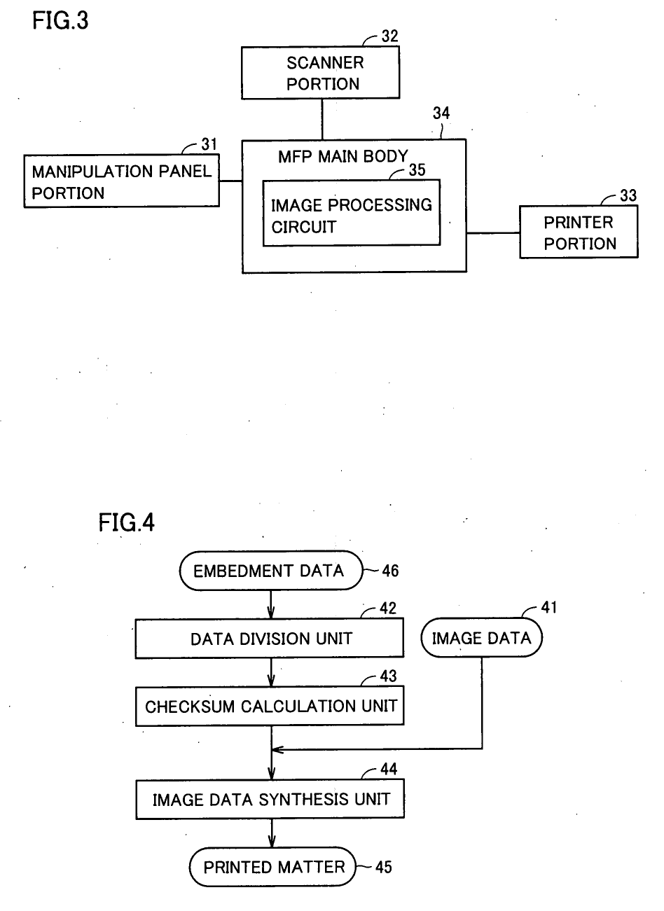

FIG. 3 illustrates another example of a system configuration of the image processing apparatus in the first embodiment of the present invention. FIG. 3 shows an example where the image processing apparatus is configured with an MFP (Multi Function Peripheral), and the image processing apparatus includes a manipulation panel portion 31, a scanner portion 32, a printer portion 33, and an MFP main body 34.

MFP main body 34 is configured with an image processing circuit 35 and the like. Receiving a user instruction through manipulation panel portion 31, image processing circuit 35 performs image processing which will be described later while controlling scanner portion 32 and printer portion 33.

FIG. 4 is a block diagram showing a functional configuration (data embedment section) of the image processing apparatus shown in FIG. 1 or 3. The image processing apparatus includes a data division unit 42 dividing embedment data 46 to be embedded in image data 41, which is an original image, into a plurality of blocks, a checksum calculation unit 43 calculating various types of checksums, an image data synthesis unit 44 superimposing data of each block expressed with dots over a background of image data 41.

A printed matter 45 is produced based on the image data synthesized by image data synthesis unit 44. Examples of embedment data 46 include various types of information such as information indicating that copy is prohibited as the original image is confidential information, password for resetting copy prohibition, information indicating an apparatus that has generated or copied the original image, and a mail address for notification via e-mail that the original image has been copied.

FIG. 5 is a flowchart for illustrating a processing procedure (data embedment section) of the image processing apparatus shown in FIG. 1 or 3. Initially, data division unit 42 divides embedment data 46 to be embedded in image data 41 into blocks (S11).

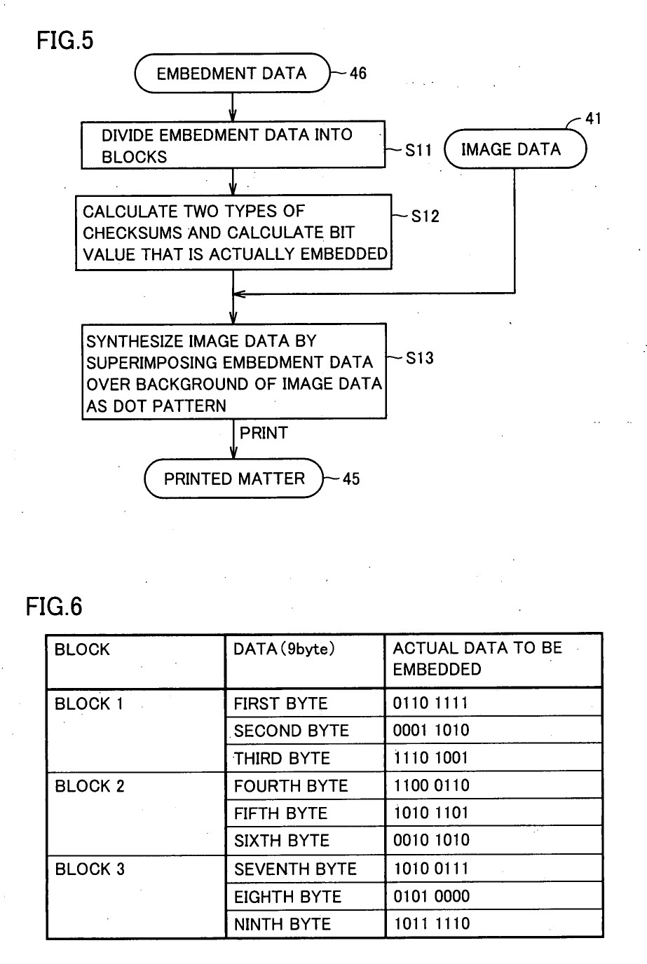

FIG. 6 illustrates an example of embedment data 46. Data 46 consists of 9 bytes as a whole. Data division unit 42 divides data 46 of 9 bytes into three blocks of 3 bytes. Actual data of blocks 1 to 3 are as shown in FIG. 6.

Thereafter, checksum calculation unit 43 calculates two types of checksums, i.e., an entire checksum of embedment data 46 and a checksum for each block (hereinafter referred to as a block checksum), so as to calculate a bit value that is actually embedded (S12).

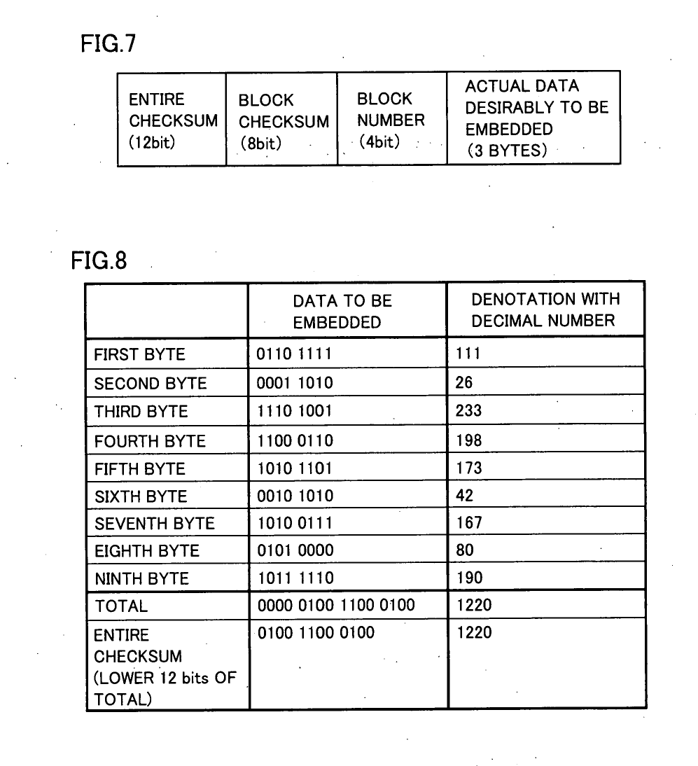

FIG. 7 illustrates an example of structure of data actually embedded in the background of image data 41. The data structure includes the entire checksum of 12 bits, the block checksum of 8 bits, a block number of 4 bits, and three pieces of actual data (3 bytes) desirably to be embedded. In an example where the embedment data is divided into three blocks, embedment data shown in FIG. 7 is produced every three blocks.

FIG. 8 illustrates a method of calculating the entire checksum. As shown in FIG. 8, the embedment data of 9 bytes is summed up, and lower 12 bits of the total value is employed as the entire checksum. It is noted that the data of 9 bytes, the total thereof, and the entire checksum are denoted with binary number and decimal number in FIG. 8. This is also the case in the figures referred to hereinafter.

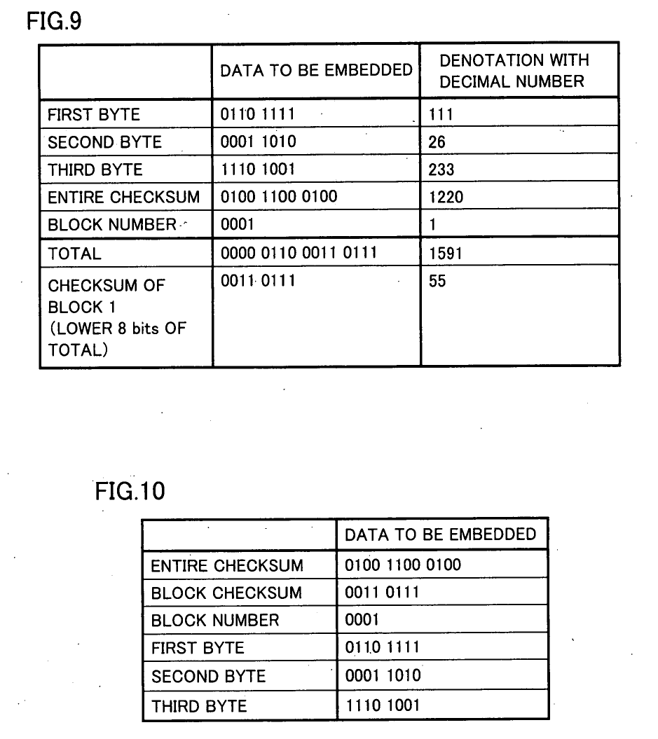

FIG. 9 illustrates a method of calculating a block checksum of a block 1. As shown in FIG. 9, the embedment data of 3 bytes, the entire checksum, and the block number are summed up, and lower 8 bits of the total value is employed as the block checksum of block 1. It is noted that the method of calculating block checksum of blocks 2 and 3 is also the same.

Here, in calculating the block checksum, the entire checksum and the block number are added to the embedment data, however, the block checksum may be calculated solely from the embedment data of that block. If the entire checksum and the block number are added to the block checksum, error thereof can also be detected.

FIG. 10 illustrates embedment data of block 1. The embedment data of block 1 includes the entire checksum, the block checksum of block 1, the block number, and actual data of 3 bytes. The embedment data of blocks 2 and 3 are also configured similarly.

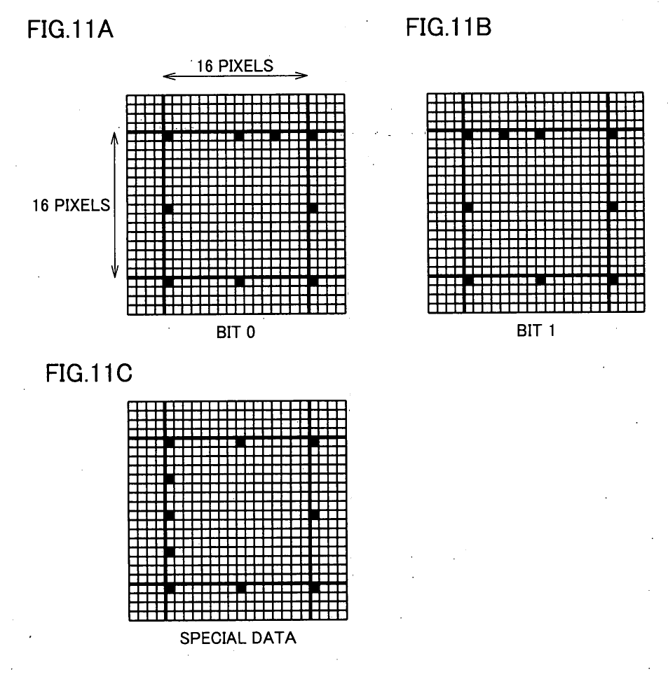

FIGS. 11A to 11C illustrate a bit pattern when data is embedded. FIG. 11A shows a bit pattern of bit “0”, where bit “0” is expressed by arranging black dots in positions shown in FIG. 11A in 16×16 pixels.

FIG. 11B shows a bit pattern of bit “1”, where bit “1” is expressed by arranging black dots in positions shown in FIG. 11B in 16×16 pixels.

FIG. 11C shows a bit pattern of special data indicating a boundary between data, where the special data is expressed by arranging black dots in positions shown in FIG. 11C in 16×16 pixels.

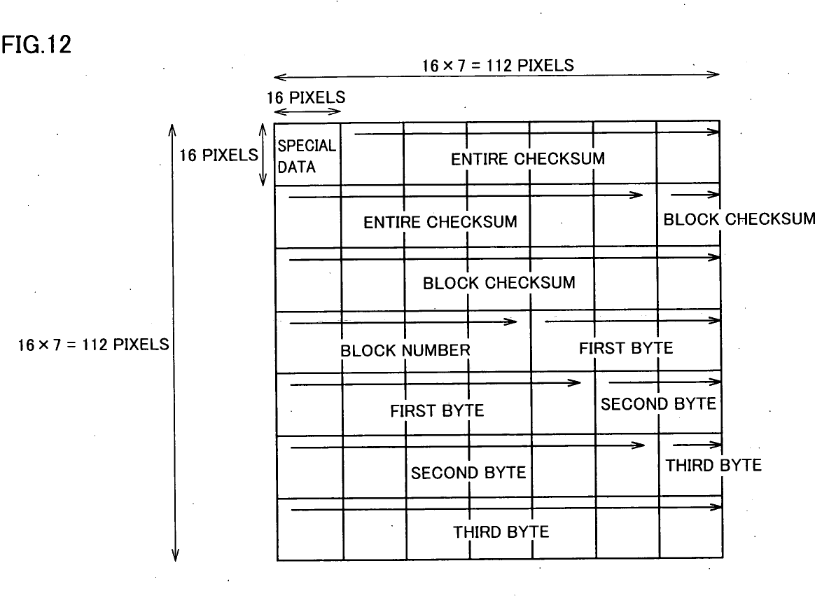

FIG. 12 illustrates rule of arrangement of the data to be embedded. The rule of arrangement is based on a pattern configuration including 7×7 bit patterns shown in FIGS. 11A to 11C, where the bit pattern of the special data (1 bit) is arranged in the upper left portion, and the bit pattern of the entire checksum (12 bits), the bit pattern of the block checksum (8 bits), the bit pattern of the block number (4 bits), and the bit pattern of the actual data of 3 bytes (8 bits each) are sequentially arranged.

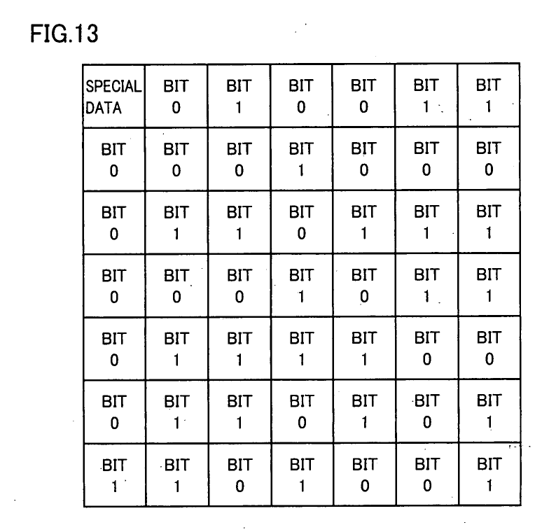

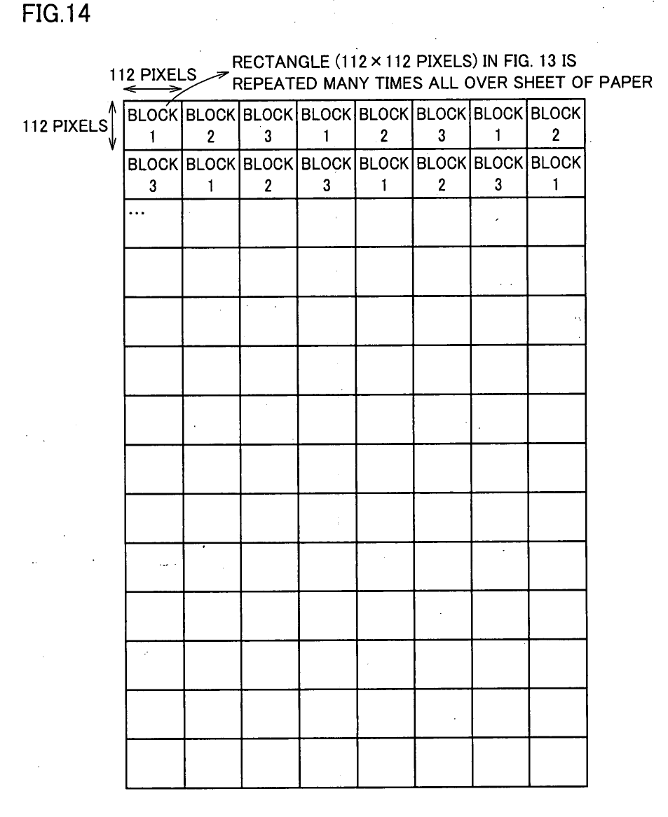

FIG. 13 illustrates a state that the data shown in FIG. 10 is actually embedded in accordance with the arrangement rule shown in FIG. 12. As shown in FIG. 13, subsequent to the special data, the values of the entire checksum, the values of the block checksum, the values of the block number, the values of the first byte of the actual data, the values of the second byte of the actual data, and the values of the third byte of the actual data are embedded.

The flowchart shown in FIG. 5 is again referred to. Finally, image data synthesis unit 44 synthesizes the image data by superimposing the embedment data over the background of the image data as the dot pattern (S13). Printed matter 45 is produced based on the resultant image data.

FIG. 14 illustrates the embedment data when it is actually printed out as the background of the image data. As shown in FIG. 14, data of 112×112 pixels shown in FIG. 13 is repeatedly arranged all over a sheet of paper in the order of block 1, block 2 and block 3, and the data is printed out as superimposed over image data such as characters to be actually printed out. If the dot pattern is embedded, for example, at 600 dpi, dots are actually quite small. Therefore, it appears to the user that a gray image has been added over the background of the printout.

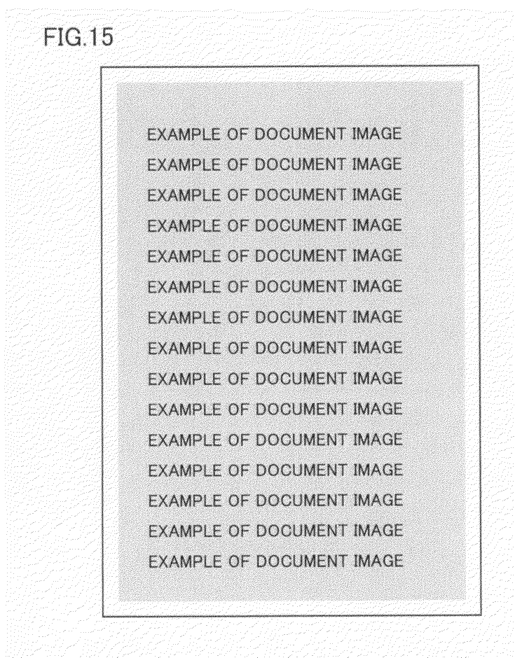

FIG. 15 illustrates an example of a printout when the data is embedded in the background of the image data and printed. As shown in FIG. 15, it appears to the user that the data is printed out with a gray image superimposed over the background of the image data.

In the description above, an example where the data is embedded as the dot pattern has been described, however, any method of embedding data by dividing the data into blocks may be employed, without limited to the embedding method described above.

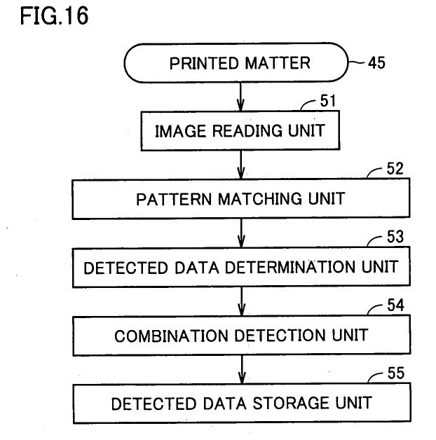

FIG. 16 is a block diagram showing a functional configuration (data detection section) of the image processing apparatus shown in FIG. 1 or 3. The image processing apparatus includes an image reading unit 51 reading an image by scanning printed matter 45, a pattern matching unit 52 detecting the embedment data by performing pattern matching of the read image, a detected data determination unit 53 determining whether the data detected by pattern matching unit 52 is correct or not, a combination detection unit 54 detecting correct combination of the embedded data, and a detected data storage unit 55 storing the detected data.

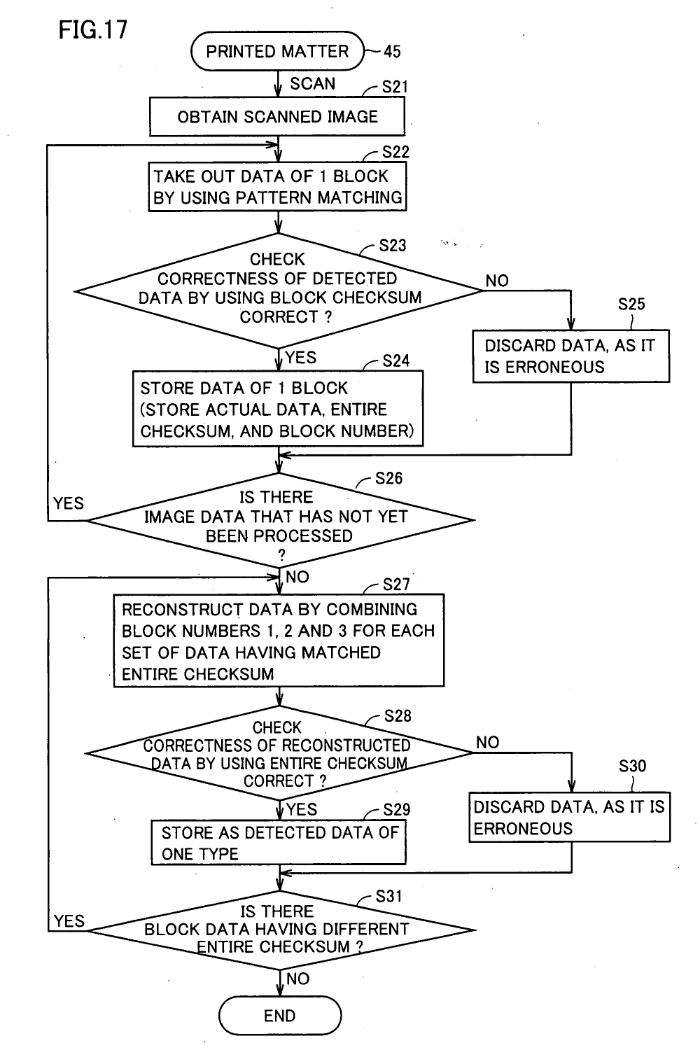

FIG. 17 is a flowchart for illustrating a processing procedure (data detection section) of the image processing apparatus shown in FIG. 1 or 3. Initially, image reading unit 51 scans printed matter 45 with scanner 15 or scanner portion 32 and obtains a scanned image (S21).

Thereafter, pattern matching unit 52 scans the image obtained by image reading unit 51 to extract a pattern of 17×17 pixels (hereinafter referred to as input pattern). Then, pattern matching unit 52 performs pattern matching of the input pattern, so as to detect the embedded data. The pattern matching processing is performed until data of 1 block is taken out (S22).

An example in which data is detected by using simple similarity will be described as exemplary pattern matching processing, however, any method capable of detecting embedded data may be employed, without limited thereto.

Simple similarity refers to such a method that, assuming that a standard pattern is defined as c=(c1, c2, . . . , c289) and the input pattern is defined as x=(x1, x2, . . . , x289), an angle between two vectors is found from the equation below, and as the angle is smaller, similarity is determined as higher. It is noted that “C” represents the inner product of the vectors and “| |” represents magnitude of the vector.

c·x/(|c|x|x|) (1)

Pattern matching unit 52 calculates cos of the angle calculated with Equation (1), and determines that, as cos is closer to “1”, the standard pattern and the input pattern are close to each other.

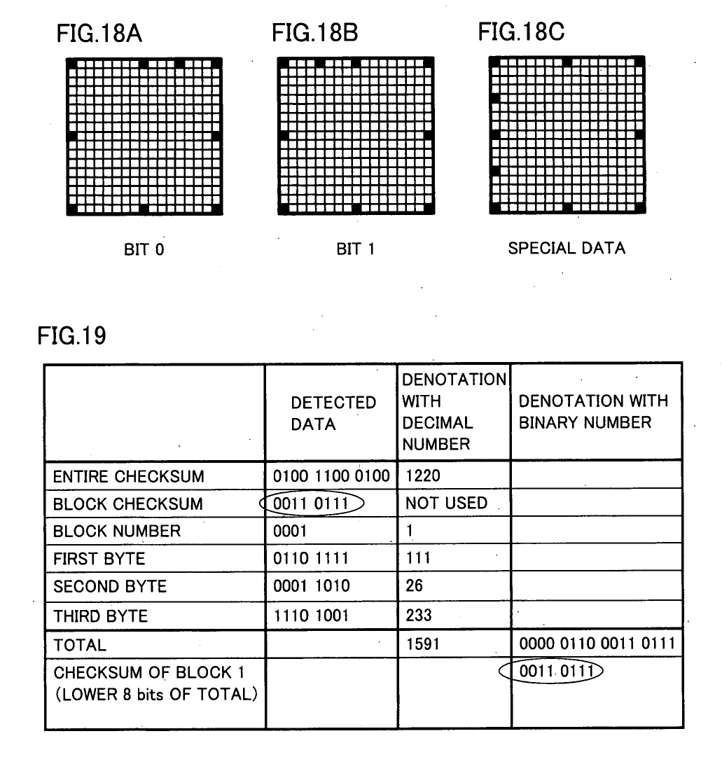

FIGS. 18A to 18C illustrate a standard pattern. FIG. 18A shows a standard pattern for bit “0”, FIG. 18B shows a standard pattern for bit “1”, and FIG. 18C shows a standard pattern for the special data.

If the cos value is not smaller than a prescribed threshold value when bit “0” shown in FIG. 1 8A is used as the standard pattern, pattern matching unit 52 makes determination as bit “0”. Meanwhile, if the cos value is not smaller than a prescribed threshold value when bit “1” shown in FIG. 18B is used as the standard pattern, pattern matching unit 52 makes determination as bit “1”. If the cos value is not smaller than a prescribed threshold value when the special data shown in FIG. 18C is used as the standard pattern, pattern matching unit 52 makes determination as the special data.

Pattern matching unit 52 performs pattern matching by extracting an input pattern of 17×17 dots while the scanned image of printed matter 45 is displaced in the left-right direction and up-down direction by 1 dot, and detects the embedded data. If the special data is detected, the special data is adopted as the reference. Then, based on a position relative to the special data, pattern matching unit 52 determines that the input pattern of 17×17 dots corresponds to any of bits and extracts data of 1 block shown in FIG. 12.

Thereafter, detected data determination unit 53 uses each data included in the extracted data of 1 block to calculate the block checksum with the calculation method described with reference to FIG. 9, and compares the calculated block checksum with the value of the block checksum included in the extracted block. Thus, detected data determination unit 53 checks correctness of the detected data (S23).

FIG. 19 illustrates an example where detected data of block 1 is correct. The block checksum is calculated from the entire checksum, the block number, and three pieces of actual data included in the extracted block. FIG. 19 shows the value of the calculated block checksum in the lower right portion. As the detected data of the block checksum included in the extracted block is equal to the value of the calculated block checksum, the detected data is determined as correct.

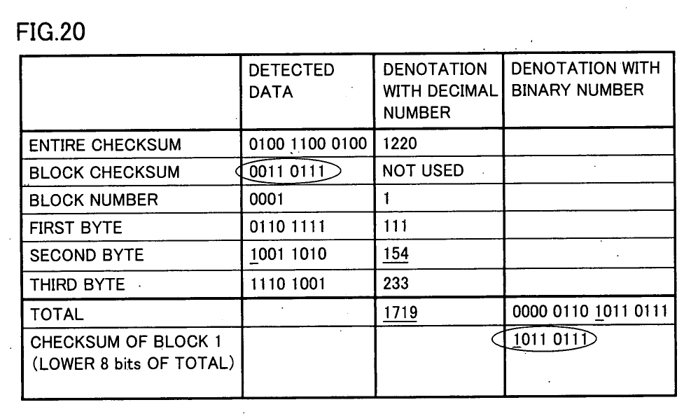

FIG. 20 illustrates an example where detected data of block 1 is erroneous. The block checksum is calculated from the entire checksum, the block number, and three pieces of actual data included in the extracted block. FIG. 20 shows the value of the calculated block checksum in the lower right portion. Then, the detected data of the block checksum included in the extracted block is compared with the value of the calculated block checksum. As shown in FIG. 20, as the second byte of the actual data is erroneous, the detected data of the block checksum is not equal to the value of the calculated block checksum. Here, the detected data is determined as erroneous.

If the detected data is determined as correct (S23, Yes), the actual data, the entire checksum and the block number included in 1 block are stored (S24). Meanwhile, if the detected data is detected as incorrect (S23, No), the data in that block is discarded as data error (S25).

Thereafter, whether processing of all image data has been completed or not is determined (S26). If there is image data that has not yet been processed (S26, Yes), the process returns to step S22 and extraction processing for a next block is performed.

If there is no image data that has not yet been processed (S26, No), combination detection unit 54 reconstructs the embedded data by combining data having block numbers 1, 2 and 3 with each other, for each set of data having matched entire checksum (S27).

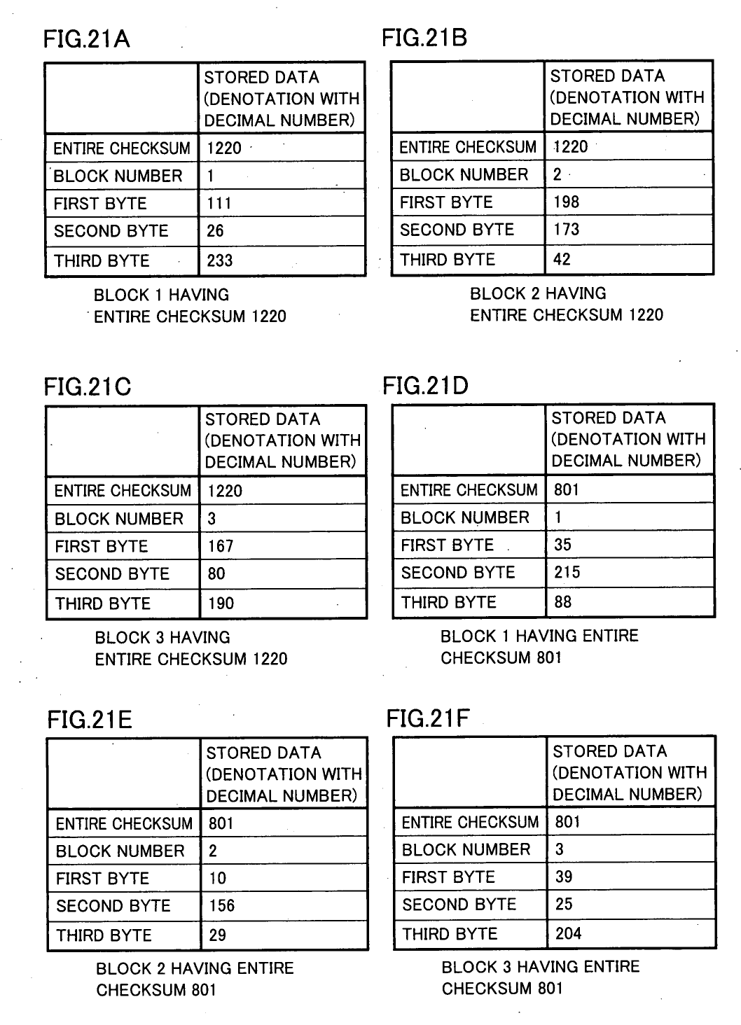

FIGS. 21A to 21F illustrate examples of the detected data determined as correct by detected data determination unit 53. FIG. 21A shows the detected data of the block having the entire checksum denoted with decimal number as “1220” and the block number “1”. FIG. 21B shows the detected data of the block having the entire checksum denoted with decimal number as “1220” and the block number “2”. FIG. 21C shows the detected data of the block having the entire checksum denoted with decimal number as “1220” and the block number “3”. Therefore, actual data (9 bytes).included in the blocks having the same entire checksum shown in FIGS. 21A to 21C are determined as the embedment data in the identical set.

Meanwhile, FIG. 21D shows the detected data of the block having the entire checksum denoted with decimal number as “801” and the block number “1”. FIG. 21E shows the detected data of the block having the entire checksum denoted with decimal number as “801” and the block number “2”. FIG. 21F shows the detected data of the block having the entire checksum denoted with decimal number as “801” and the block number “3”. Therefore, actual data (9 bytes) included in the blocks having the same entire checksum shown in FIGS. 21D to 21F are determined as the embedment data in the identical set. Thus, FIGS. 21A to 21F include two types of data.

Thereafter, combination detection unit 54 determines whether the reconstructed data is correct or not, based on the entire checksum (S28). If the reconstructed data is correct (S28, Yes), detected data storage unit 55 stores the set of the detected data as the detected data of one type (S29). On the other hand, if the reconstructed data is not correct (S28, No), the set of the detected data is discarded as erroneous (S30).

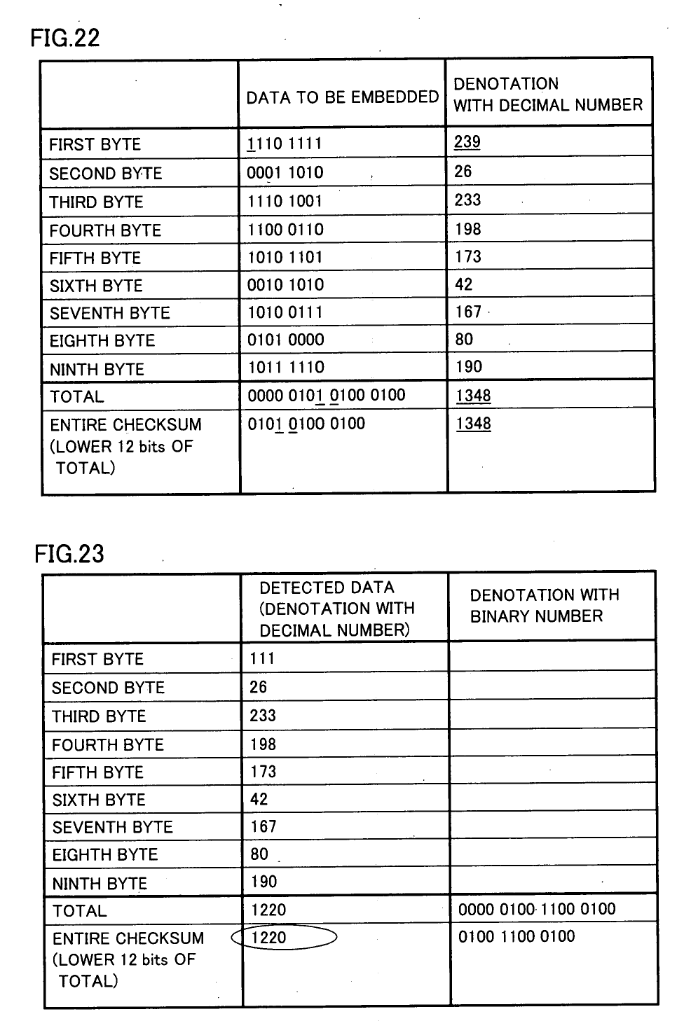

FIG. 22 shows a value of entire checksum when reconstructed data is erroneous. FIG. 22 shows an example where the most significant bit in the first byte of the actual data is erroneously set to “1” and the value of the calculated entire checksum is “1348” in denotation with decimal number. By comparing this value of the entire checksum with the detected value of the entire checksum “1220”, it is found that the reconstructed data is erroneous.

FIG. 23 shows a value of entire checksum when reconstructed data is correct. As all the actual data are correct in FIG. 23, the value of the calculated entire checksum is “1220” in denotation with decimal number. By comparing this value of the entire checksum with the detected value of the entire checksum “1220”, it is found that the reconstructed data is correct.

Finally, whether or not there is block data having different entire checksum is determined (S31). If there is block data having different entire checksum (S31, Yes), the process returns to step S27 and the processing thereafter is repeated. On the other hand, if there is no block data having different entire checksum (S31, No), the process ends.

Meanwhile, even though solely one type of data is embedded in one printout, in an example where two or more printouts having different data embedded are placed on the scanner and an image is scanned, data cannot correctly be detected unless the data are recognized as different from each other.

In the embodiment described above, the embedment data is identified based on the entire checksum representing a value specific thereto. Alternatively, data may be embedded, with a print number being allocated as identification information specific to the embedment data in each printout. Here, if there are a plurality of printers, the same number may be allocated to different embedment data. Accordingly, in order to prevent such a problem, desirably, such data as a model or a serial number of a printer is also embedded together in each printout.

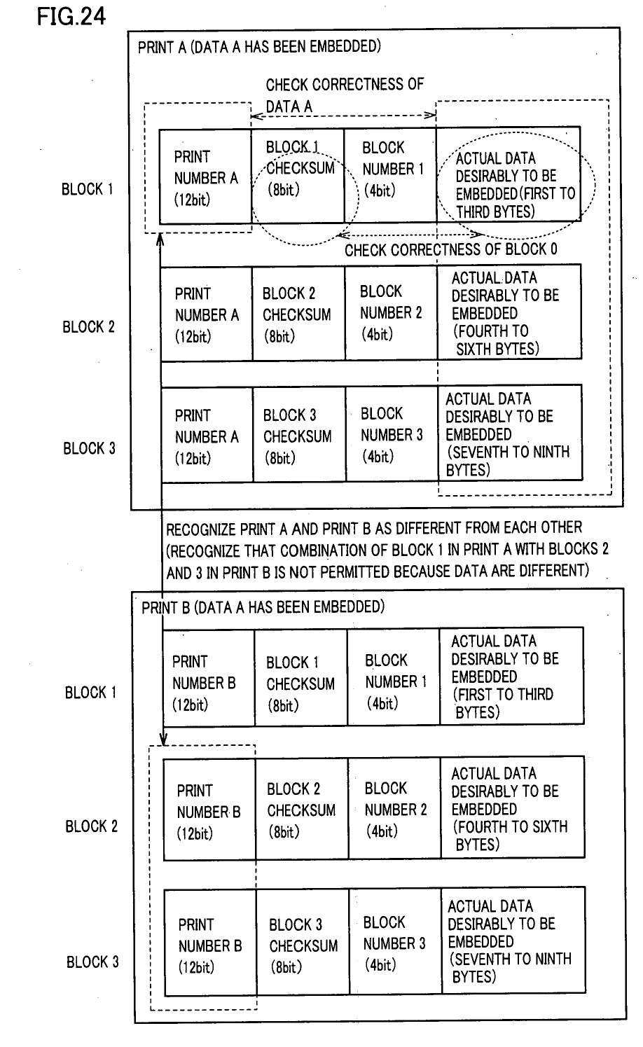

FIG. 24 illustrates an example where two printouts having different actual data A and B embedded are scanned when a print number is included in the embedment data and the data is printed out. For example, even if block 1 is detected from print A and blocks 2 and 3 are detected from print B, the actual data of print A and the actual data of print B are recognized as different data because the print number is different, and therefore the data are prevented from being erroneously combined.

As described above, according to the image processing apparatus in the present embodiment, the actual data to be embedded is divided into a plurality of blocks, and the embedment data including the block checksum calculated for each block and the entire checksum (or identification information specific to the actual data) is superimposed over the background of the image data. Therefore, by scanning the printed matter and detecting such data, verification of correctness of the embedded data and identification of the embedded data can simultaneously be carried out.

In addition, as correctness of the block data is verified by using the block checksum and correctness of the entire actual data is verified by using the entire checksum, verification of the embedded actual data can further accurately be carried out.

Moreover, as the entire checksum is used for identification of the embedment data, even if two printouts having different embedment data embedded are arranged side by side and scanned, each printout can correctly be identified.

### Second Embodiment

An image processing apparatus according to a second embodiment of the present invention is different from the image processing apparatus according to the first embodiment only in that embedding a value calculated by using a hash function such as MD (Message Digest) 5 (128 bits), SHA (Secure Hash Algorithm)-1 (160 bits), or the like, or a value generated by performing bit blend processing, instead of calculating and embedding a value of checksum. Therefore, detailed description of redundant configuration and functions will not be repeated.

For details of MD5, reference should be made to Ronald L. Rivest, “The MD5 Message-Digest Algorithm” in RFC (Request for Comments) 1321 of IETF (Internet Engineering Task Force), April 1992, pp. 1-21, and for-details of SHA-1, reference should be made to “Secure Hash Standard” in FIPS PUBS (Federal Information Processing Standards Publications) 180-2, Aug. 1, 2002, pp. i-iv and 1-7].

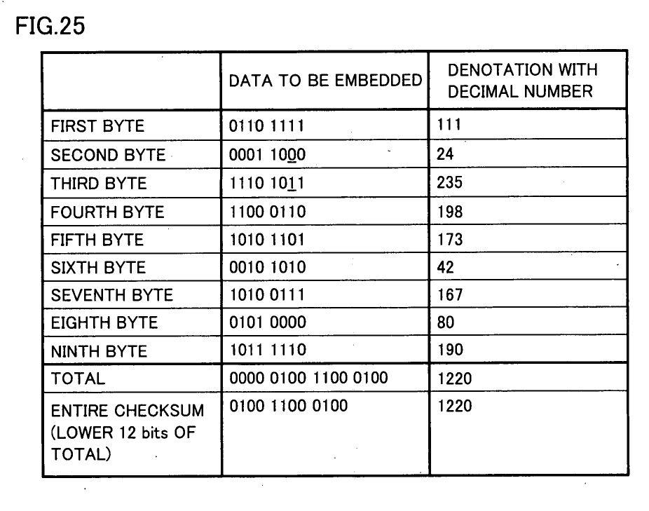

FIG. 25 illustrates an example where a value of checksum is calculated and embedded. If bit 1 in the second byte of the actual data is erroneously detected as “0” and bit 1 in the third byte of the actual data is erroneously detected as “1”, the calculated value of the entire checksum turns out to be a correct value. Accordingly, when correctness of the data is verified by using the checksum, such erroneous detection cannot be discovered.

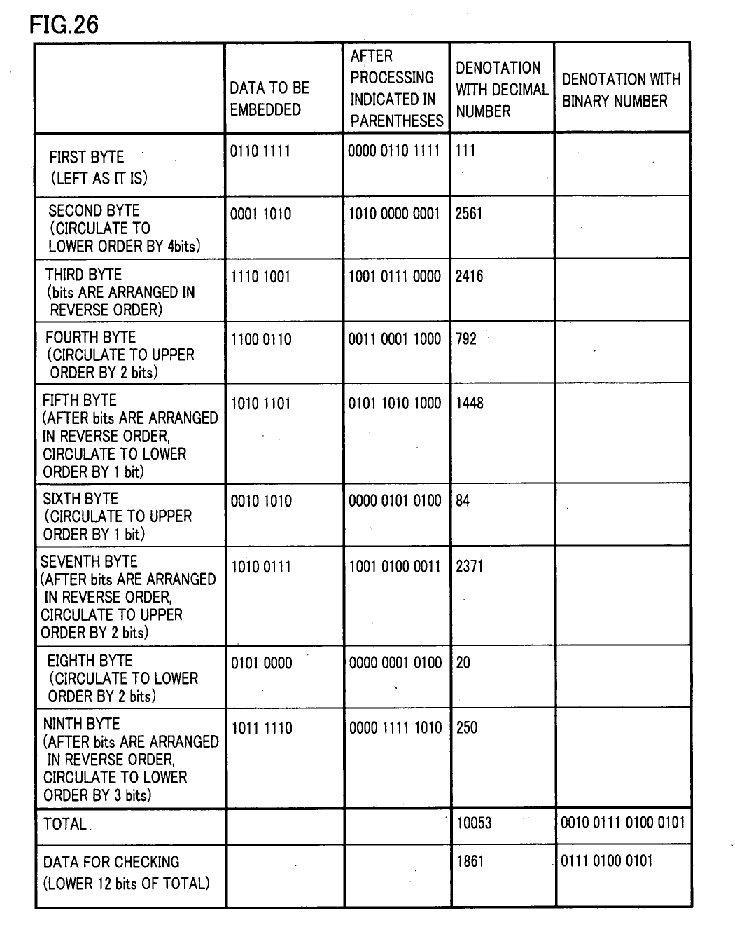

FIG. 26 illustrates an example where correctness of data is verified by using bit blend processing as used in a hash function. In FIG. 26, after the actual data of 8 bits is converted to data of 12 bits, bit blend is performed. Here, as an embodiment where an amount of data to be embedded is small is described, an embodiment without using a hash function is described. If the embedment data is greater than 1 Kbyte for example, however, MD5 may be employed as it is.

The first byte of the data to be embedded is left as it is. As to the second byte of the data to be embedded, the data is circulated (shifted) to the lower order by 4 bits. Therefore, lower 4 bits including the least significant bit move to the upper order. As to the third byte of the data to be embedded, bits are arranged in reverse order.

As to the fourth byte of the data to be embedded, the data is circulated (shifted) to the upper order by 2 bits. As to the fifth byte of the data to be embedded, bits are arranged in reverse order, and thereafter the data is circulated (shifted) to the lower order by 1 bit. As to the sixth byte of the data to be embedded, the data is circulated (shifted) to the upper order by 1 bit.

As to the seventh byte of the data to be embedded, bits are arranged in reverse order, and thereafter the data is circulated (shifted) to the upper order by 2 bits. As to the eighth byte of the data to be embedded, the data is circulated (shifted) to the lower order by 2 bits. As to the ninth byte of the data to be embedded, bits are arranged in reverse order, and thereafter the data is circulated (shifted) to the lower order by 3 bits.

After bit blend as above is performed, data are summed up and lower 12 bits are extracted. Then, data for checking shown in the lower right portion of FIG. 26 is obtained.

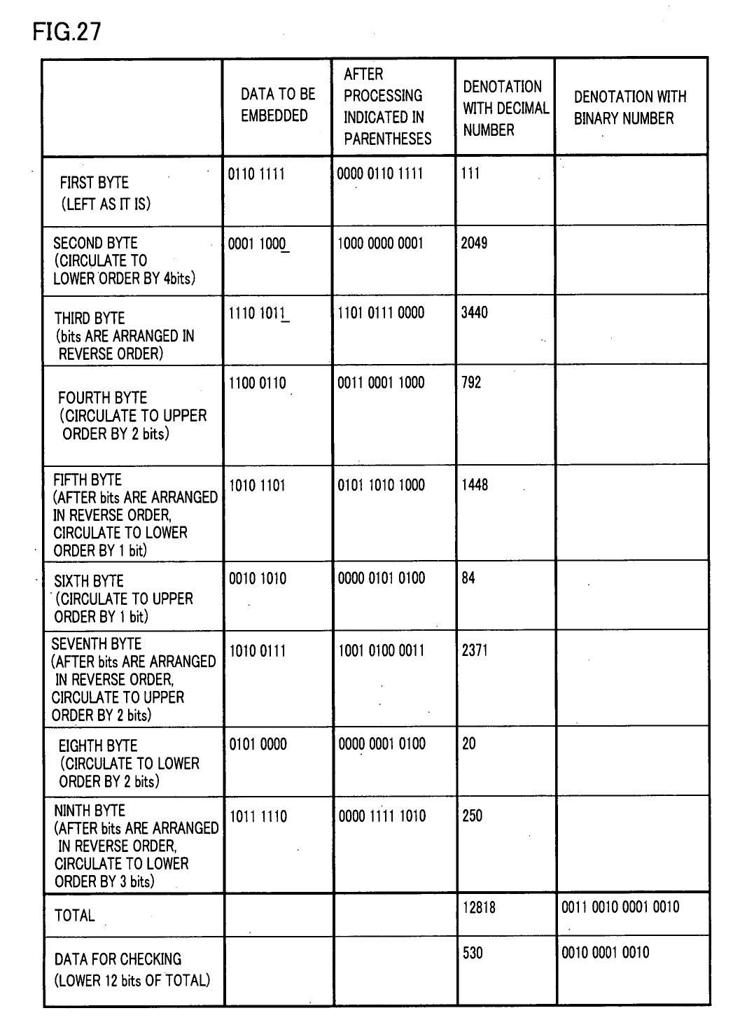

FIG. 27 illustrates data for checking, generated after bit blend shown in FIG. 26 is performed, when data is erroneous. In FIG. 27, as in FIG. 25, bit 1 in the second byte of the actual data is erroneously detected as “0” and bit 1 in the third byte of the actual data is erroneously detected as “1”. Even if the actual data contains such an error, the data for checking has a value different from the correct value, and error in the actual data can be detected.

As shown in FIG. 25, if the actual data are simply added up, the data of upper 4 bits of the entire checksum appears only at the time of carry of the digit. Accordingly, erroneous coincidence of the value of the entire checksum basically occurs only with a probability of ½¹². Actually, however, as in the example shown in FIG. 25 or the like, coincidence of the value of the checksum occurs at a higher probability. Therefore, checking is more effective by performing bit blend as shown in FIG. 26.

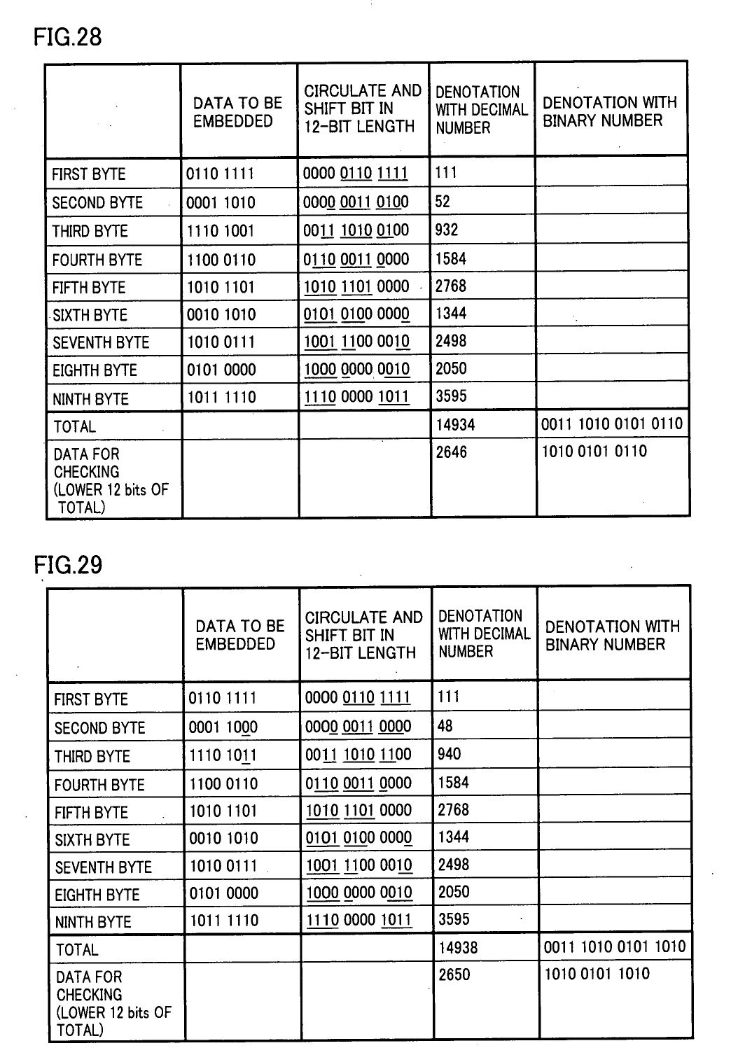

FIG. 28 illustrates another method of calculating data for checking. In FIG. 28, the first byte of the data to be embedded is left as it is, the data in the second to ninth bytes are circulated (shifted) by 1 to 8 respectively, and thereafter data are summed up and lower 12 bits are extracted. Thus, data for checking shown in the lower right portion of FIG. 28 is obtained.

FIG. 29 illustrates data for checking, generated after bit blend shown in FIG. 28 is performed, when data is erroneous. In FIG. 29, as in FIG. 25, bit 1 in the second byte of the actual data is erroneously detected as “0” and bit 1 in the third byte of the actual data is erroneously detected as “1”. Even if the actual data contains such an error, the data for checking has a value different from the correct value, and error in the actual data can be detected.

Thus, addition is performed after data to be added evenly appears in calculation result in accordance with a bit length of the data for checking. Therefore, the bit length of the data for checking can effectively be utilized. If the data length itself of the data to be embedded is short and the data length of the data for checking is also short, data to be added should only appear evenly in the calculation result in accordance with the bit length of the data for checking. Therefore, by using the calculation method as shown in FIG. 28, the need for-complicated bit blend as with the “hash function is obviated. Accordingly, in software implementation, load in the operation processing is reduced, while in hardware implementation, operation can be performed with a simplified circuit.

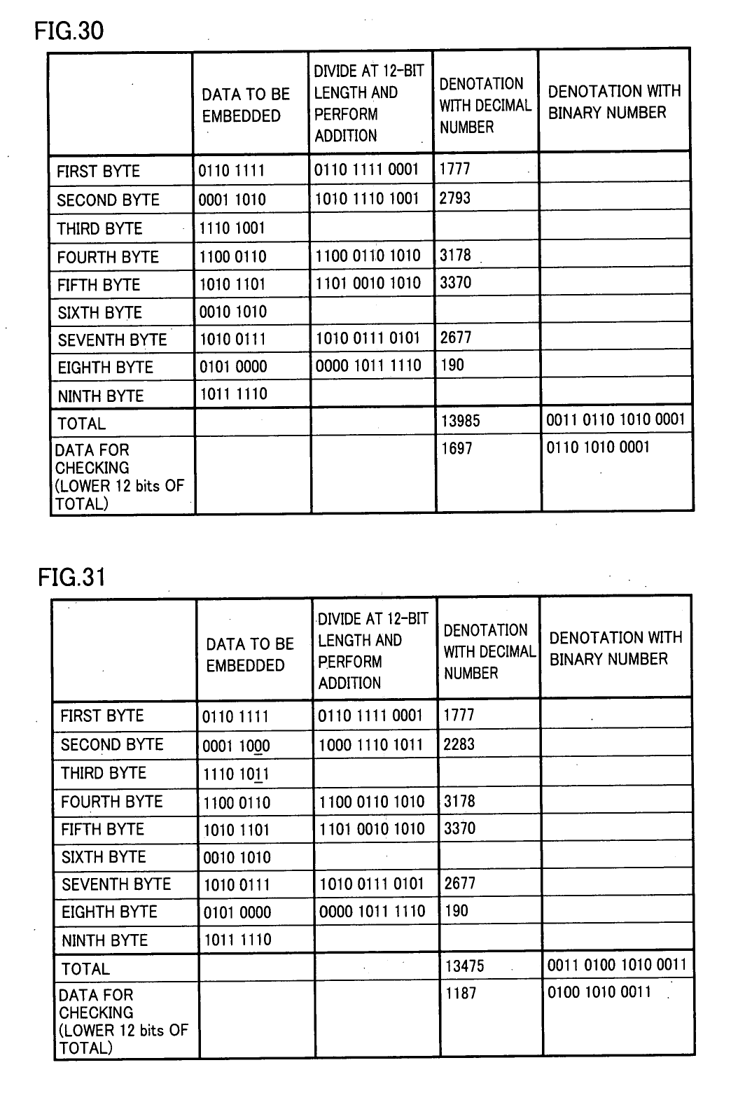

FIG. 30 illustrates yet another method of calculating data for checking. In FIG. 30, the first to third bytes of the actual data are coupled, and thereafter coupled data is divided into two pieces of data each having 12-bit length. Similarly, two pieces of data each having 12-bit length are generated from the fourth to sixth bytes of the actual data, and two pieces of data each having 12-bit length are generated from the seventh to ninth bytes of the actual data. Then, six pieces of data of 12-bit length are summed up and lower 12 bits are extracted. Thus, data for checking shown in the lower right portion of FIG. 30 is obtained.

FIG. 31 illustrates data for checking, generated after bit blend shown in FIG. 30 is performed, when data is erroneous. In FIG. 31, as in FIG. 25, bit 1 in the second byte of the actual data is erroneously detected as “0” and bit 1 in the third byte of the actual data is erroneously detected as “1”. Even if the actual data contains such an error, the data for checking has a value different from the correct value and error in the actual data can be detected.

Thus, addition is performed after data to be added evenly appears in calculation result in accordance with a bit length of the data for checking. Therefore, the bit length of the data for checking can effectively be utilized.

As described above, according to the image processing apparatus in the present embodiment, addition is performed after bit blend of the actual data, so as to generate data for checking. Therefore, checking as to whether the detected data is correct or not can further accurately be performed.

In the description above, the data for checking used instead of the entire checksum has been described in detail, and with the method the same as such, data for checking instead of the block checksum may be produced.

### Third Embodiment

An image processing apparatus according to a third embodiment of the present invention is different from the image processing apparatus according to the first embodiment only in that embedding a value calculated by using cyclic redundancy check (hereinafter referred to as CRC), instead of calculating and embedding a value of checksum. Therefore, detailed description of redundant configuration and functions will not be repeated.

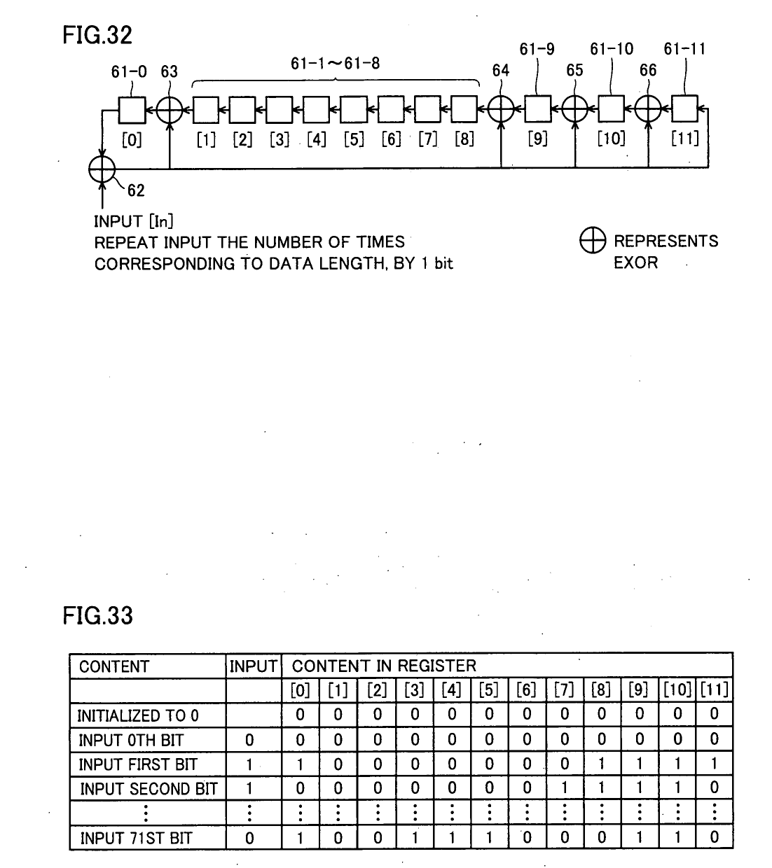

FIG. 32 illustrates an example of a CRC circuit. The CRC circuit includes registers [0] to [11] (61-0 to 61 -11) of 12 bits, and exclusive-OR (hereinafter referred to as EXOR) circuits 62 to 66.

Registers [0] to [11] (61-0 to 61-11) hold a value in synchronization with a clock. The content of each bit in the register before the value is updated in response to the clock is denoted as [X] (X=0 to 11), the content of each bit in the register after the value is updated in response to the clock is denoted as [X′], and input data of 1 bit is denoted as [In]. Then, bits in the registers have relation as follows.
(1) [11]′=[In]EXOR[0]
(2) [10]′=([In]EXOR[0])EXOR[11]
(3) [9]′=([In]EXOR[0])EXOR[10]
(4) [8]′=([In]EXOR[0])EXOR[9]
(5) [7]′=[8]
(6) [6]′=[7]
(7) [5]′=[6]
(8) [4]′=[5]
(9) [3]′=[4]
(10) [2]′=[3]
(11) [1]′=[2]
(12) [0]′=([In]EXOR[0])EXOR[ 1]

For example, when the embedment data of 9 bytes shown in FIG. 6 is input as [In] to the CRC circuit by I bit, the operation shown with (1) to (12) above is performed 72 times. Finally, the value that remains in registers [0] to [11] is employed as a CRC value.

FIG. 33 illustrates variation of each bit in the register when the embedment data of 9 bytes shown in FIG. 6 is successively input to the CRC circuit. First, the content in registers [0] to [11] is initialized. Then, when the first bit [In]=1 is input after input of 0th bit [In]=0, the content in [0] and [8] to [11] is set to “1” and the content of other bits is set to “0”. Thereafter, when the second bit [In]=1 is input, the content in [7] to [10] is set to “1”, and the content of other bits is set to “0”. When the 71st bit [In]=0 is input, the CRC value shown in FIG. 33 is obtained.

As described above, according to the image processing apparatus in the present embodiment, as the CRC circuit is used to generate data for checking, checking as to whether the detected data is correct or not can further accurately be performed.

It is noted that an identical unidirectional function does not necessarily have to be used for generating data for checking for the entire embedment data and data for checking for each block, and different unidirectional functions may be used. Examples of the unidirectional function include a checksum, a hash function, and cyclic redundancy check, however, the unidirectional function is not limited as such. Any unidirectional function that can be used for verification of data and can decrease the number of bits of the data may be employed.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing method for embedding embedment data in an original image, comprising the steps of:
dividing said embedment data into a plurality of blocks;
calculating a specific value from data for each resultant block, by using a unidirectional function;.
generating identification information specific to said embedment data; and
embedding said specific value, said identification information, and said data of each block in said original image for each block.

2. The image processing method according to claim 1, wherein
said unidirectional function is a checksum.

3. The image processing method according to claim 1, wherein
said unidirectional function is a hash function.

4. The image processing method according to claim 1, wherein
said unidirectional function is a function for performing addition after performing bit blend on the data.

5. The image processing method according to claim 4, wherein
said unidirectional function is a function for performing addition after performing shift operation on the data.

6. The image processing method according to claim 4, wherein
said unidirectional function is a function for performing addition after dividing the data at a prescribed bit length.

7. The image processing method according to claim 1, wherein
said unidirectional function is cyclic redundancy check.

8. The image processing method according to claim 1, wherein
said identification information is a value calculated from entire said embedment data by using a second unidirectional function.

9. The image processing method according to claim 8, wherein
said second unidirectional function is a checksum.

10. The image processing method according to claim 8, wherein
said second unidirectional function is a hash function.

11. The image processing method according to claim 8, wherein
said second unidirectional function is a function for performing addition after performing bit blend on the data.

12. The image processing method according to claim 11, wherein
said second unidirectional function is a function for performing addition after performing shift operation on the data.

13. The image processing method according to claim 11, wherein
said second unidirectional function is a function for performing addition after dividing the data at a prescribed bit length.

14. The image processing method according to claim 8, wherein
said second unidirectional function is cyclic redundancy check.

15. The image processing method according to claim 1, wherein
said data of each block is embedded in said original image, together with a block identification number provided for each block.

16. A data detection method of detecting embedment data embedded in a printed image, comprising the steps of:
reading an image from a printed matter;
detecting data for each block of the embedment data, a specific value calculated from the data for each block by using a unidirectional function, and identification information specific to said embedment data, from the read image;
verifying correctness of the data based on a value calculated from the detected data for each block by using said unidirectional function and the detected specific value; and
determining combination of the data for each block, based on the detected identification information.

17. The data detection method according to claim 16, wherein
said unidirectional function is a checksum.

18. The data detection method according to claim 16, wherein.
said unidirectional function is a hash function.

19. The data detection method according to claim 16, wherein
said unidirectional function is a function for performing addition after performing bit blend on the data.

20. The data detection method according to claim 19, wherein
said unidirectional function is a function for performing addition after performing shift operation on the data.

21. The data detection method according to claim 19, wherein
said unidirectional function is a function for performing addition after dividing the data at a prescribed bit length.

22. The data detection method according to claim 16, wherein
said unidirectional function is cyclic redundancy check.

23. The data detection method according to claim 16, wherein
said identification information is a value calculated from entire said embedment data by using a second unidirectional function, and
said data detection method further comprises the step of verifying correctness of the data based on the value calculated from entire said detected embedment data by using said second unidirectional function and the detected identification information.

24. The data detection method according to claim 23, wherein
said second unidirectional function is a checksum.

25. The data detection method according to claim 23, wherein
said second unidirectional function is a hash function.

26. The data detection method according to claim 23, wherein
said second unidirectional function is a function for performing addition after performing bit blend on the data.

27. The data detection method according to claim 26, wherein
said second unidirectional function is a function for performing addition after performing shift operation on the data.

28. The data detection method according to claim 26, wherein
said second unidirectional function is a function for performing addition after dividing the data at a prescribed bit length.

29. The data detection method according to claim 23, wherein
said second unidirectional function is cyclic redundancy check.

30. The data detection method according to claim 16, further comprising the steps of:
detecting a block identification number provided for each block of the embedment data from the read image; and
reproducing entire said embedment data from the data for each block, based on said block identification number.

31. An image processing apparatus for embedding embedment data in an original image, comprising:
a division unit dividing said embedment data into a plurality of blocks;
a calculation unit calculating a specific value from data for each block resultant from division by said division unit, by using a unidirectional function;
a generation unit generating identification information specific to said embedment data; and
an embedding unit embedding said specific value, said identification information, and said data of each block in said original image for each block.

32. A data detection apparatus detecting embedment data embedded in a printed image, comprising:
a reading unit reading an image from a printed matter;
a detection unit detecting data for each block of the embedment data, a specific value calculated from the data for each block by using a unidirectional function, and identification information specific to said embedment data, from the image read by said reading unit;
a verification unit verifying correctness of the data based on a value calculated, by using said unidirectional function, from the data for each block detected by said detection unit and the specific value detected by said detection unit; and
a determination unit determining combination of the data for each block, based on the identification information detected by said detection unit.

33. A computer readable recording medium storing a computer program for embedding embedment data in an original image, by causing a computer to execute the steps of:
dividing said embedment data into a plurality of blocks;
calculating a specific value from data for each resultant block, by using a unidirectional function;
generating identification information specific to said embedment data; and
embedding said specific value, said identification information, and said data of each block in said original image for each block.

34. A computer readable recording medium storing a computer program for detecting embedment data embedded in a printed image, by causing a computer to execute the steps of:
reading an image from a printed matter;
detecting data for each block of the embedment data, a specific value calculated from the data for each block by using a unidirectional function, and identification information specific to said embedment data, from the read image;
verifying correctness of the data based on a value calculated from the detected data for each block by using said unidirectional function and the detected specific value; and
determining combination of the data for each block, based on the detected identification information.
